(19) United States
(12) Patent Application Publication
(10) Pub. No.: US 2011/0016089 A1
(43) Pub. Date: Jan. 20, 2011

(54) RESTORING DATA TO A MOBILE DEVICE

(75) Inventors: Gordie Freedman, Palo Alto, CA (US); Jacob Farkas, Sunnyvale, CA (US); Toby Charles Wood Paterson, San Francisco, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/504,392

(22) Filed: Jul. 16, 2009

(51) Int. Cl. G06F 12/16; G06F 12/00

(52) U.S. Cl. 707/640; 707/E17.01; 707/E17.044; 711/E12.001; 711/E12.103

(57) ABSTRACT

Methods, systems, and apparatus, including computer programs encoded on a computer storage medium, for backing up and restoring data to a mobile device. In general, one aspect of the subject matter described in this specification can be embodied in methods that include the actions of receiving data from a mobile device to be included in a backup, the data including data associated with one or more mobile device applications; storing the data in a backup archive; generating a backup mapping file for each of the mobile device applications, each backup mapping file identifying each file in the backup associated with the respective application; and using the backup mapping files to restore the corresponding applications to the mobile device.

### TECHNICAL FIELD

This specification relates to backing up and restoring data to a mobile device.

### BACKGROUND

Mobile devices can be used to perform a number of different functions. For example, mobile devices can be used for communication (e.g., telephone, e-mail, text), storing or listening to music, as well as for running various applications (e.g., games, productivity tools).

Data can be lost or corrupted on a mobile device. For example, a user may need to perform a reset on the mobile device that erases some data. A user can also manually delete data from the mobile device, for example, by deleting particular installed applications or files from the mobile device.

Some conventional mobile devices allow a user to back up data stored on the mobile device, e.g., to one or more computers or storage devices. This data can be restored to the mobile device if the data on the mobile device becomes lost or corrupted. However, such a restoration operation is typically all or nothing such that the entire mobile device has to be restored with the backup data.

### SUMMARY

This specification describes technologies relating to backing up and restoring data to a mobile device.

In general, one aspect of the subject matter described in this specification can be embodied in methods that include the actions of receiving data from a mobile device to be included in a backup, the data including data associated with one or more mobile device applications; storing the data in a backup archive; generating a backup mapping file for each of the mobile device applications, each backup mapping file identifying each file in the backup associated with the respective application; and using the backup mapping files to restore the corresponding applications to the mobile device. Other embodiments of this aspect include corresponding systems, apparatus, and computer program products.

These and other embodiments can optionally include one or more of the following features. The method further includes presenting a backup restoration interface, the backup restoration interface including a selectable representation of each application having a backup mapping file. Each backup mapping file further includes a graphical file used to represent the application in the backup restoration interface. The method further includes receiving an input to restore application data to a mobile device; presenting a backup restoration interface, the backup restoration interface including a selectable representation of each application having a backup mapping file; receiving a user selection of an application to restore; and restoring the selected application to the mobile device.

Restoring the selected application includes identifying one or more files associated with the selected application in the backup mapping file; identifying files corresponding to the identified one or more files in the backup archive; and restoring the identified files in the backup archive to the mobile device. The method further includes generating one or more incremental backups of the mobile device, each incremental backup including data changed from a previous backup. The method further includes presenting a backup restoration interface, the backup restoration interface including multiple user interface representations of previous backups of the mobile device, each backup corresponding to a previous state of the mobile device, each user interface representation presenting one or more applications of the mobile device corresponding to the previous state and available for restoration. The method further includes receiving a selection of a particular user interface representation; receiving a selection of a particular application in the selected user interface representation; and restoring the selected application.

In general, one aspect of the subject matter described in this specification can be embodied in methods that include the actions of receiving data from a mobile device to be included in a backup, the data including data associated with one or more files on a mobile device; storing the data in a backup archive; generating a backup mapping file for one or more associated files of the mobile device, each backup mapping file identifying each file in the backup associated with the respective one or more associated files; and using the backup mapping files to restore the corresponding files to the mobile device. Other embodiments of this aspect include corresponding systems, apparatus, and computer program products.

These and other embodiments can optionally include one or more of the following features. The method further includes receiving an input to restore file data to a mobile device; presenting a backup restoration interface, the backup restoration interface including a selectable representation of the one or more files having a backup mapping file; receiving a user selection of one or more files to restore; and restoring the selected files to the mobile device.

In general, one aspect of the subject matter described in this specification can be embodied in methods that include the actions of receiving an input to restore application data to a mobile device; generating a restoration interface, the restoration interface including a selectable representation of each application available for restoration according to a corresponding backup mapping file, the backup mapping file associating files in the backup archive for the application; receiving a user selection of a particular application to restore; and restoring the application to the mobile device including using the backup mapping file for the selected application to identify files in the backup archive to restore.

Particular embodiments of the subject matter described in this specification can be implemented so as to realize one or more of the following advantages. Users can restore particular content backed up on a mobile device without restoring all data. Users can visually locate particular content, e.g., applications for restoration using a restoration user interface. A backup user interface can allow users to navigate through multiple backup states to identify a particular version of data to restore.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 is a flow chart showing an example method for backing up data of a mobile device.

FIG. 2 is a schematic diagram illustrating the backup of mobile device data.

FIG. 3 is a flow chart showing an example method for restoring data to a mobile device.

FIG. 4 is an example interface for managing a mobile device.

FIG. 5 is an example restoration interface.

FIG. 6 is an example restoration interface showing multiple backup states.

FIG. 7 shows an example system architecture.

Like reference numbers and designations in the various drawings indicate like elements.

### DETAILED DESCRIPTION

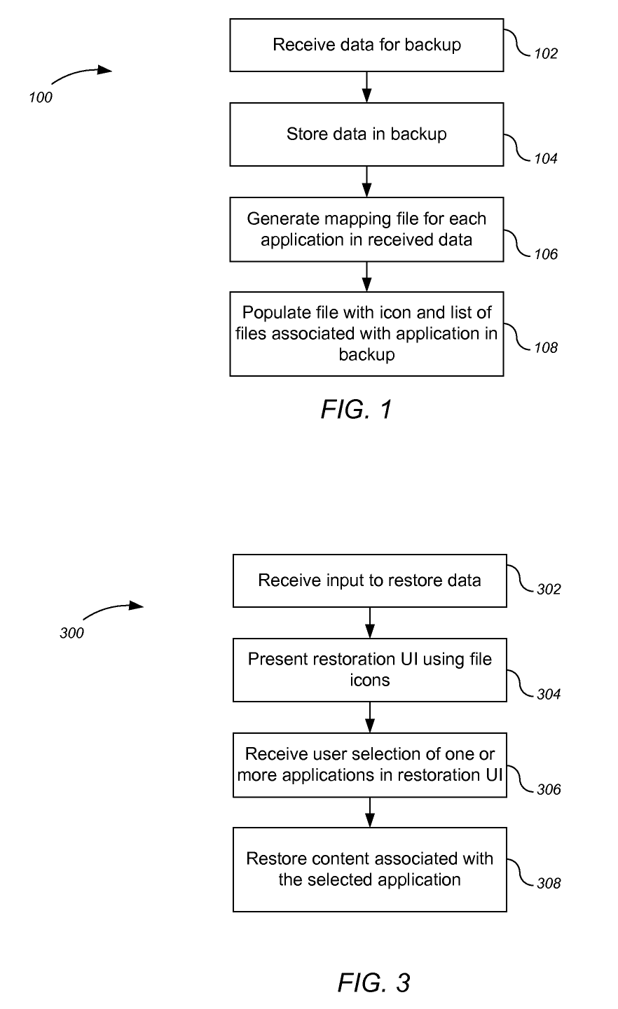

FIG. 1 is flow chart showing an example method 100 for backing up data of a mobile device. For convenience, the method 100 will be described with respect to a system that performs the method 100.

The system receives 102 mobile device data for storing in a backup archives In some implementations, a user couples the mobile device to a computer or storage device. The mobile device can be coupled by a physical connection (e.g., a cable) or through a wireless or cellular network. A backup operation can be initiated automatically when the mobile device is coupled, a particular application is executed, through manual initiation by the user, or as triggered by particular events or backup criteria (e.g., particular types of changes to data from a previous backup).

In some implementations, the received data is a full backup of all data on the mobile device. Alternatively, in some other implementations, the received data is only a portion of the data on the mobile device. For example, the data can include only particular types of data (e.g., particular file types, applications, or other data). Additionally or alternatively, the received data can be incremental data that only includes data that is changed from a previous backup operation. In some implementations, metadata associated with the data of the mobile device is used to identify changed data relative to a prior backup operation. For example, metadata associated with files or applications can identify a last modification date.

The system stores 104 the received data in a backup archives The data can be stored in the backup archive in a number of different data structures. In some implementations, the data is stored in a backup archive that models a particular file structure. For example, hierarchical file system, e.g., HFS (Hierarchical File System) or other file system e.g., UFS (Unix File System), NTFS (New Technology File System), and FAT (File Allocation Table). Alternative structures can be used to store the data.

The system generates 106 a backup mapping file for each application in the received mobile device data. Each application is identified with the received data. The system then generates a corresponding backup mapping file for the application. The backup mapping file associates application files in the backup archive with a single backup mapping file. For example, for a photo viewing application, a photo application file can be generated.

In some implementations, the backup mapping file can also be generated for individual files or file types in addition to applications. For example, photo files can have individual mapping files generated or can be combined for a single backup mapping file.

In particular, in some implementations, the mobile device, the device sends the mapping along with the files to be backed up. In some implementations, the mappings are defined by developers, e.g., to explicitly identify ˜/Safari/Bookmarks.html as belonging to the Safari application. Alternatively, the mapping can identify anything in ˜/Safari to belong in the Safari application. In some other implementations, e.g., for third party application, the mapping can be dynamically generated by determining what application container a given file is located within.

The system populates 108 the backup mapping file with identifiers for an icon and files associated with the application or other content. In particular, the files in the backup belonging to the application are identified in the backup mapping file such that the particular files in the backup can be identified from the backup mapping file. Thus, using the backup mapping file, the system can identify and retrieve each of the associated files from the backup archives Additionally, the identified icon can provide a semantic representation of the application, for example, for use in a restoration interface. In some implementations, the icon is identified from the application data received from the mobile device (e.g., as an icon used to represent the application on the mobile device). Alternatively, in some other implementations, the icon is retrieved from a remote location or a generic icon is generated to represent the application.

In some alternative implementations, the backup mapping file corresponds to an individual file or files rather than an application. The backup mapping file includes identifiers for the corresponding file or files in the backup archive as well as an identifier for an icon to represent the file or files in a restoration interface. For example, for a photo file, the backup mapping file can identify the location of the photo file in the backup archives The identified icon can be a generic icon for the particular file type (e.g., for image files). Alternatively, the system can generate a thumbnail of the photo file for use as the icon.

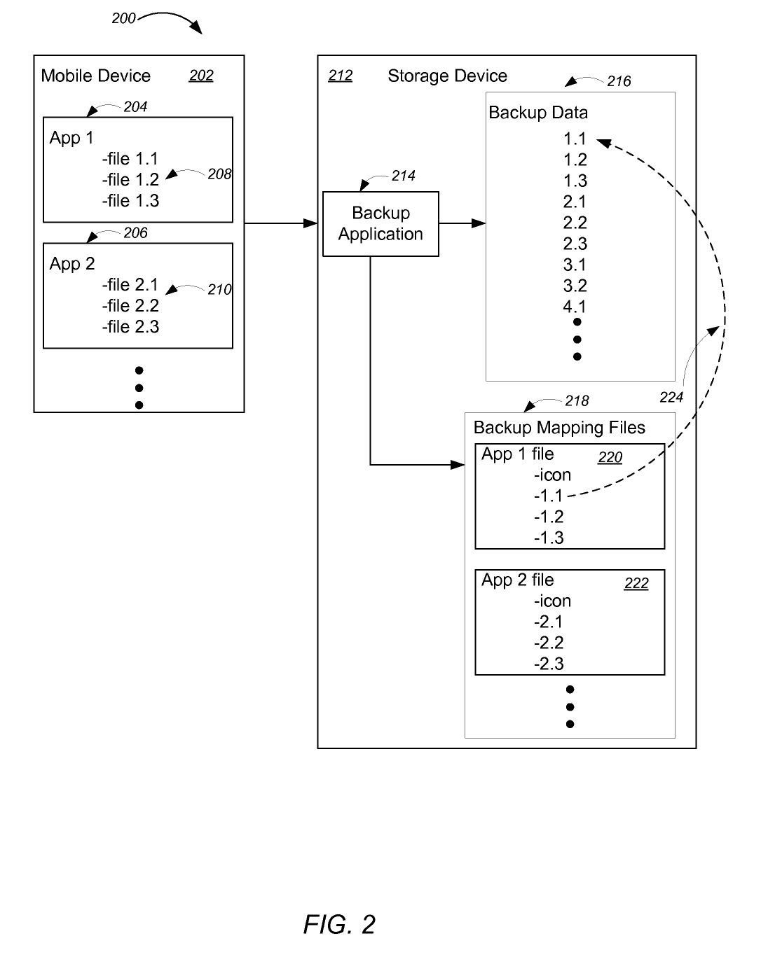

FIG. 2 is a schematic diagram 200 illustrating the backup of mobile device data. Diagram 200 shows mobile device 202 including first application 204 and second application 206. First application 204 includes files 208 associated with first application 204. Similarly, second application 206 includes files 210 associated with second application 206. For example, first application 204 can be a photos application and files 208 can include files for executing the photos application, as well as individual photo files (e.g., jpg images).

Storage device 212 receives data (e.g., the first application 204 or one or more files 208 associated with first application 204 when an incremental backup is performed) from mobile device 202 for a backup operation. Storage device 212 can be part of a computer, a remote storage device, a network storage device, or other storage device. For example, the storage device can be a remote storage device coupled to a computer through which the mobile device interacts. Backup application 214 can receive the data and store the received data in backup archive 216. Backup archive 216 includes a set of files or other data stored for later restoration. Backup archive 216 allows for the storage of multiple versions of the mobile device's applications, files, or other items, for example within storage device 212, or in some alternative implementations, an external storage repository. In some implementations, the backup application also allows a user to select any of the stored versions and use the particular selected version to initiate a restoration of backup data to mobile device 202.

Backup application 214 can also use the received data to generate backup mapping files 218 for each application. For example, backup mapping files 220 and 222 represent first application 204 and second application 206. Each of the backup mapping files 220 and 222 identify files associated with the application represented by the respective backup mapping file. Each identified file is associated with a corresponding file in the backup archive 216. In particular, arrow 224 shows the mapping from an identified file in backup mapping file 220 to the corresponding file in backup archive 216. Additionally, each of backup mapping files 220 and 222 includes a respective icon used to represent the application in a restoration interface.

In some implementations, an incremental backup is performed that includes data changes to an application that has already been included in a previous backup. The backup mapping file for the application is copied and modified to identify the modified files for the current backup, as well as the files from the prior backup in order to define a consistent version of the application for the current incremental backup.

FIG. 3 is a flow chart showing an example method 300 for restoring data to a mobile device. For convenience, the method 300 will be described with respect to a system that performs the method 300.

The system receives 302 an input to restore data to a mobile device. For example, a user can access a management application for the mobile device and provide an input indicating a request to restore data. The user can request restoration, for example, because of a problem with the mobile device that caused a loss or corruption of data. Alternatively, the user may have deleted particular data (e.g., a particular application or file associated with an application) either unintentionally or with a later desire to restore the deleted data (e.g., user can accidentally delete a photo that they want to recover).

In some alternative implementations, the system prompts the user to initiate a restoration operation for the mobile device. For example, when the user couples the mobile device to the system, the system can identify changes relative to a prior backup of the mobile device. When changes are detected, e.g., the deletion of an application, the system can prompt the user to restore the deleted application.

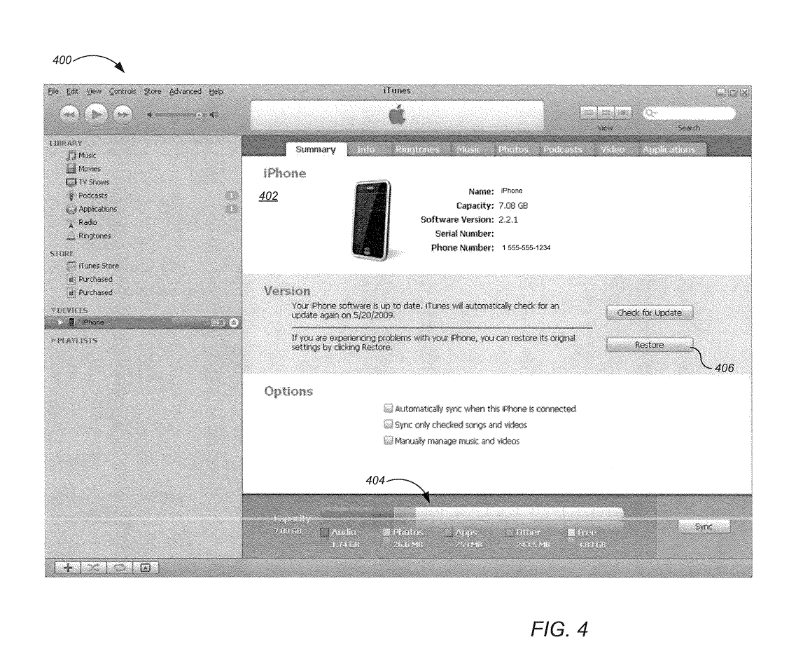

FIG. 4 is an example interface 400 for managing a mobile device. The interface 400 represents an iTunes interface for managing local data as well as mobile devices. In particular, management panel 402 is shown for managing a mobile device. The mobile device includes various types of data. For example, capacity bar 404 indicates that the mobile device include audio content, photos, and applications. Other types of data can be stored on the mobile device. Management panel 402 also includes a restore button 406, which, when selected, allows the user to initiate a restoration process to the mobile device.

As shown in FIG. 3, system presents 304 a restoration interface using icons from backup mapping files. Specifically, the system generates a restoration interface that identifies the individual applications or other content included in the backup for which backup mapping files have been generated. Thus, a user can view individual applications for restoration rather than being required to restore all data on the mobile device collectively. The system uses the icons identified for each backup mapping file to present a semantic representation of the various applications available for restoration. In some implementations, the restoration interface allows a user to select different mobile devices. For example, a user can use more than one mobile device. Each mobile device can have different data stored in the backup archives The user can select the particular mobile device to restore data to.

In some other implementations, the restoration interface can be initiated from another user interface, for example, from a search or finder user interface or another application for managing data.

The system receives 306 a user selection of one or more applications in the restoration interface. The user can select an individual application or can use a multiple selection technique to select two or more applications for restoration (e.g., using a cursor or keystrokes to select the particular icons representing the applications to restore).

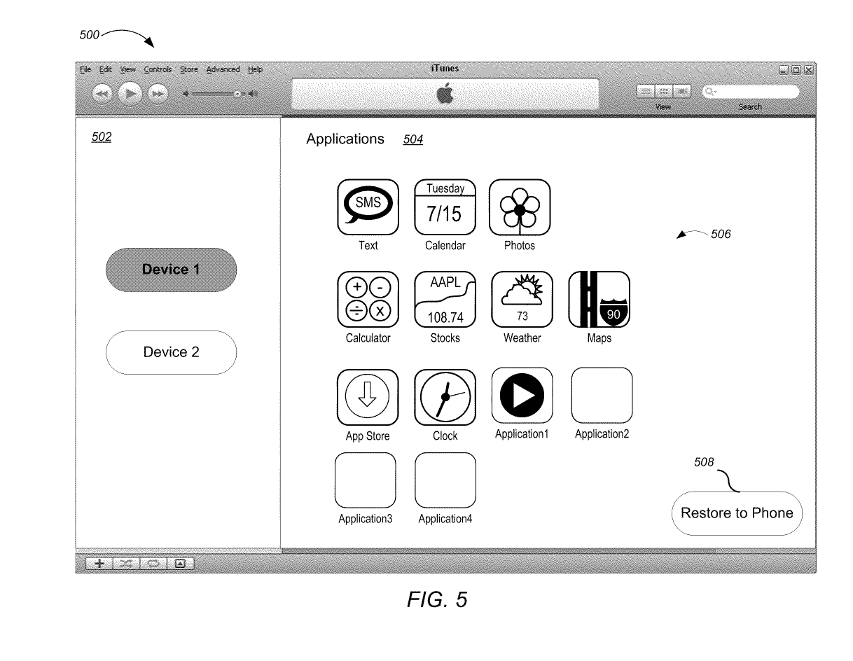

FIG. 5 is an example restoration interface 500. Restoration interface 500 includes device selection panel 502 and application selection panel 504. In particular, device selection panel 502 allows a user to select a particular mobile device to which data is to be restored. As shown in restoration interface 500, selection panel 502 includes device 1 and device 2. Additionally, device 1 is shown as selected. As a result of the device selection, application selection panel 504 shows applications backed up for device 1 and available for restoration.

In particular, application selection panel 504 shows a number of applications 506 stored in a backup archive and available for restoration. For example, applications 506 include a photo application, a weather application, a map application. Other applications (e.g., application1, application2, application3, application4) can represent gaming applications, productivity applications, utility applications, or other types of applications, utilities, and in some implementations, files or other content for which a backup mapping file has been generated.

A restore to mobile device button 508 allows the user to initiate a restore operation on particular selected applications to the identified mobile device.

As shown in FIG. 3, the system restores 308 data associated with the selected content (e.g., files associated with a selected application). The system identifies files or other data associated with the selected content and performs a restoration of that data to the mobile device. For example, the system can identify one or more files associated with a selected application and restore those files to the mobile device in order to restore the application or to restore a particular state of the application.

Specifically, the system uses the backup mapping file associated with the selected icon in the restoration interface to identify the files in the backup archive for restoration. For example, if a user selects the photos application in the restoration interface based on a corresponding icon, the system identifies the files listed in the photos application backup mapping file (which is associated with the selected icon). The system then identifies each of the files from the backup mapping file in the backup archives The files can include both files for executing the photos application, as well as individual photo files. The files are then restored to the mobile device, thereby restoring the photos application to the mobile device.

In some implementations, the system stores multiple backups in the backup archives For example, each time the mobile device is backed up, a new backup version can be generated. In some implementations, a full backup is generated. In other alternative implementations, each backup after an initial full backup is an incremental backup that tracks changed information. A user can select a particular backup (e.g., based on the date or time of the backup) using the restoration interface such that particular applications from that backup can be restored.

In some implementations, backup data is stored as a series of snapshots. A snapshot representation of the mobile device can provide a consistent data set for a particular point in time. The snapshot can be used to generate a representation of the stored data corresponding to the state of the mobile device at the time the backup was performed. In some implementations, the snapshots are presented in a restoration interface as arranged in a cascading stack, where each next snapshot moving through the stack corresponds to a point in time further in the past relative to the most recent snapshot (e.g., presented at the top of the stack). In storing incremental backups, only changed data is stored along with references to corresponding data in an earlier backup for the unchanged data.

Specifically, in some implementations, one copy of original data (e.g., applications, files, items, information portions, directories, images, system parameters, playlists, address books, e-mails, e-mail folders, application states, preferences, and the like) is stored in the archive as backup data (e.g., an original version of the data). When one or more subsequent sets of backup data, or versions, of the data are generated through subsequent backup operations, the backup data can contain only the differences between a current data version and the prior backup data, thereby saving storage space.

In some implementations, a storage device (e.g., storage device 212 of FIG. 2) can be used to store the original backup data, as well as links pointing to the original backup data. The links can be hard links which reference, or point to, physical data, or as another example can be symbolic links that reference another file on the storage device (e.g., by name or location). For example, if a particular item, such as a file, folder, icon, or application/machine state information, has not changed from one captured user interface view version to another, the backup application can create and manage a link from an entry representing the latest captured item version to the item in the previously captured item version.

A user of the system can access the item either through the previously captured item version or by using the link in the latest captured version. This allows the system to store one copy of each unique instance of an item versus storing a separate identical copy of an item for every captured version of a user interface view. In some implementations, it can be transparent to the user that the access through the previously captured item version is direct and the access through the latest captured item version is through the link.

In some implementations, the backup application is capable of discerning between a substantive change (e.g. an application has been removed) and a non-substantive change (e.g. the play count within an iTunes playlist has been updated, a high score on a game has changed, or several changes cancel each other out) through its interaction with the mobile device. Additionally, in some implementations, only substantive changes are included in backup operations. The backup application can create, for example, a list of modified elements (e.g., files) to be used when a backup operation is eventually triggered. In one implementation, the backup application can monitor the system for periods of inactivity. The backup application can then trigger a backup operation during a period of time in which the backup operation will not cause a system slowdown for an active user.

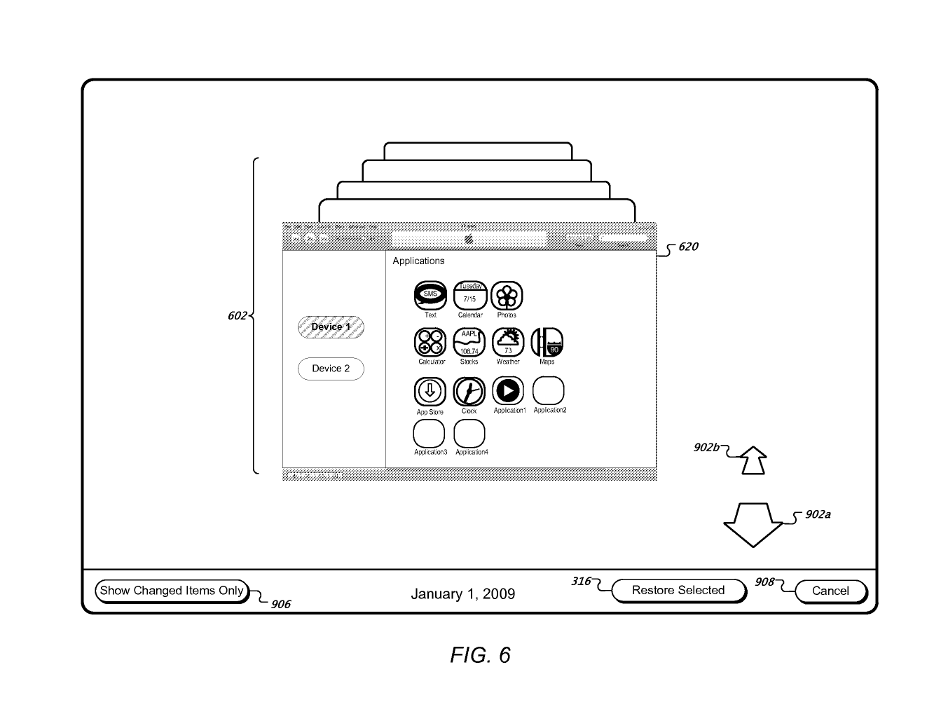

FIG. 6 is an example restoration interface 600 showing multiple backup states. Restoration interface 600 includes snapshots 602, navigation controls 606a-b, and control bar 608 including, for example, “cancel” control 610, “only show changes” control 612, and “restore” control 614. Control bar 608 can also include date display 616, which displays the date of the topmost snapshot of snapshots 602.

The “cancel” control 610 can allow the user to cancel the restoration of one or more mobile device applications. In some implementations, canceling a restoration will also lead to exiting the backup interface and returning, for example, to a mobile device management interface (e.g., management interface 400 of FIG. 4). The “restore” control 614 can allow a user to restore a selected item in a snapshot to the mobile device.

In some implementations, “restore” control 614 can be used to restore the entire contents of the selected snapshot e.g., restore all of the application in the current snapshot to the mobile device. The “only show changes” control 612 can allow a user to select whether or not snapshots without changed applications or application data will be presented in restoration interface 600. In some implementations, “only show changes” control 612 can be toggled to display a “show all” control.

Top snapshot 620 of the stack of snapshots 602 represents the most recent backup of the mobile device. Date display 616 displays the date of the snapshot as “Jan. 1, 2009”. The contents of top snapshot 620 correspond to the applications present on the mobile device at the time the snapshot was taken. In some alternative implementations, the top snapshot can instead present the current content of the mobile device such that the user can compare, e.g., the current applications with the applications in the backups.

A user can navigate to a particular snapshot using navigation controls 606a-b. When the user identifies particular content in a snapshot to restore (e.g., a particular application), the user can select the icon representing that content and then select the restore control 614. The system then automatically restores the content associated with the selection to the mobile device.

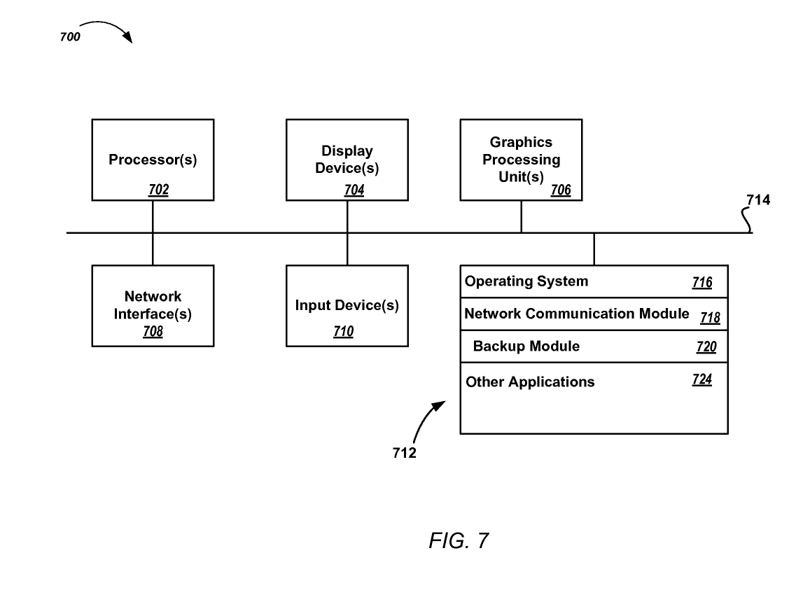

FIG. 7 shows an example system architecture 700. The system architecture 700 is capable of performing operations for query expansion using ad logs and statistical machine translation. The system architecture 700 includes one or more processors 702 (e.g., IBM PowerPC, Intel Pentium 4, etc.), one or more display devices 704 (e.g., CRT, LCD), graphics processing units 706 (e.g., NVIDIA GeForce, etc.), network interface 708 (e.g., Ethernet, FireWire, USB, etc.), input devices 710 (e.g., keyboard, mouse, etc.), and one or more computer-readable mediums 712. These components exchange communications and data using one or more buses 714 (e.g., EISA, PCI, PCI Express, etc.).

The term “computer-readable medium” refers to any medium that participates in providing instructions to processor 702 for execution. The computer-readable medium 712 further includes operating system 716 (e.g., Mac OS®, Windows®, Linux, etc.), a network communication module 718, backup module 720, and other applications 724.

Operating system 716 can be multi-user, multiprocessing, multitasking, multithreading, real-time and the like. Operating system 716 performs basic tasks, including but not limited to: recognizing input from input devices 710; sending output to display devices 704; keeping track of files and directories on computer-readable mediums 712 (e.g., memory or a storage device); controlling peripheral devices (e.g., disk drives, printers, etc.); and managing traffic on one or more buses 714. Network communications module 718 includes various components for establishing and maintaining network connections (e.g., software for implementing communication protocols, such as TCP/IP, HTTP, Ethernet, etc.).

Backup module 720 provides various software components for performing the various functions for backing up mobile device data and presenting and restoring individual mobile device applications, as described with respect to FIGS. 1-6.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving data from a mobile device to be included in a backup, the data including data associated with one or more mobile device applications;
storing the data in a backup archive;
generating a backup mapping file for each of the mobile device applications, each backup mapping file identifying each file in the backup associated with the respective application; and
using the backup mapping files to restore the corresponding applications to the mobile device.

2. The method of claim 1, further comprising:
presenting a backup restoration interface, the backup restoration interface including a selectable representation of each application having a backup mapping file.

3. The method of claim 2, where each backup mapping file further includes a graphical file used to represent the application in the backup restoration interface.

4. The method of claim 1, further comprising:
receiving an input to restore application data to a mobile device;
presenting a backup restoration interface, the backup restoration interface including a selectable representation of each application having a backup mapping file;
receiving a user selection of an application to restore; and
restoring the selected application to the mobile device.

5. The method of claim 4, where restoring the selected application comprises:
identifying one or more files associated with the selected application in the backup mapping file;
identifying files corresponding to the identified one or more files in the backup archive; and
restoring the identified files in the backup archive to the mobile device.

6. The method of claim 1, further comprising:
generating one or more incremental backups of the mobile device, each incremental backup including data changed from a previous backup.

7. The method of claim 6, further comprising:
presenting a backup restoration interface, the backup restoration interface including multiple user interface representations of previous backups of the mobile device, each backup corresponding to a previous state of the mobile device, each user interface representation presenting one or more applications of the mobile device corresponding to the previous state and available for restoration.

8. The method of claim 7, further comprising:
receiving a selection of a particular user interface representation;
receiving a selection of a particular application in the selected user interface representation; and
restoring the selected application.

9. A method performed by data processing apparatus, the method comprising:
receiving data from a mobile device to be included in a backup, the data including data associated with one or more files on a mobile device;
storing the data in a backup archive;
generating a backup mapping file for one or more associated files of the mobile device, each backup mapping file identifying each file in the backup associated with the respective one or more associated files; and
using the backup mapping files to restore the corresponding files to the mobile device.

10. The method of claim 9, further comprising:
receiving an input to restore file data to a mobile device;
presenting a backup restoration interface, the backup restoration interface including a selectable representation of the one or more files having a backup mapping file;
receiving a user selection of one or more files to restore; and
restoring the selected files to the mobile device.

11. A method performed by data processing apparatus, the method comprising:
receiving an input to restore application data to a mobile device;
generating a restoration interface, the restoration interface including a selectable representation of each application available for restoration according to a corresponding backup mapping file, the backup mapping file associating files in the backup archive for the application;
receiving a user selection of a particular application to restore; and
restoring the application to the mobile device including using the backup mapping file for the selected application to identify files in the backup archive to restore.

12. A system comprising:
one or more processors configured to perform operations comprising:
receiving data from a mobile device to be included in a backup, the data including data associated with one or more mobile device applications;
storing the data in a backup archive;
generating a backup mapping file for each of the mobile device applications, each backup mapping file identifying each file in the backup associated with the respective application; and
using the backup mapping files to restore the corresponding applications to the mobile device.

13. The system of claim 12, further operable to perform operations comprising:
presenting a backup restoration interface, the backup restoration interface including a selectable representation of each application having a backup mapping file.

14. The system of claim 13, where each backup mapping file further includes a graphical file used to represent the application in the backup restoration interface.

15. The system of claim 12, further operable to perform operations comprising:
receiving an input to restore application data to a mobile device;
presenting a backup restoration interface, the backup restoration interface including a selectable representation of each application having a backup mapping file;
receiving a user selection of an application to restore; and
restoring the selected application to the mobile device.

16. The system of claim 15, where restoring the selected application comprises:
identifying one or more files associated with the selected application in the backup mapping file;
identifying files corresponding to the identified one or more files in the backup archive; and
restoring the identified files in the backup archive to the mobile device.

17. The system of claim 12, further operable to perform operations comprising:
generating one or more incremental backups of the mobile device, each incremental backup including data changed from a previous backup.

18. The system of claim 17, further operable to perform operations comprising:
presenting a backup restoration interface, the backup restoration interface including multiple user interface representations of previous backups of the mobile device, each backup corresponding to a previous state of the mobile device, each user interface representation presenting one or more applications of the mobile device corresponding to the previous state and available for restoration.

19. The system of claim 18, further operable to perform operations comprising:
receiving a selection of a particular user interface representation;
receiving a selection of a particular application in the selected user interface representation; and
restoring the selected application.

20. A system comprising:
one or more processors configured to perform operations including:
receiving data from a mobile device to be included in a backup, the data including data associated with one or more files on a mobile device;
storing the data in a backup archive;
generating a backup mapping file for one or more associated files of the mobile device, each backup mapping file identifying each file in the backup associated with the respective one or more associated files; and
using the backup mapping files to restore the corresponding files to the mobile device.

21. The system of claim 20, further configured to perform operations comprising:
receiving an input to restore file data to a mobile device;
presenting a backup restoration interface, the backup restoration interface including a selectable representation of the one or more files having a backup mapping file;
receiving a user selection of one or more files to restore; and
restoring the selected files to the mobile device.

22. A system comprising:
one or more processors configured to perform operations including:
receiving an input to restore application data to a mobile device;
generating a restoration interface, the restoration interface including a selectable representation of each application available for restoration according to a corresponding backup mapping file, the backup mapping file associating files in the backup archive for the application;
receiving a user selection of a particular application to restore; and
restoring the application to the mobile device including using the backup mapping file for the selected application to identify files in the backup archive to restore.
